(19) United States
(12) Patent Application Publication
(10) Pub. No.: US 2016/0205330 A1
(43) Pub. Date: Jul. 14, 2016

(54) A METHOD AND AN APPARATUS FOR OBTAINING AN IMAGE FILE INCLUDING AN ALPHA CHANNEL WITH A PHOTOGRAPHIC CAMERA

(71) Applicant: FAST FORWARD IMAGING GMBH, Berlin (DE)

(72) Inventors: Anna Rojahn, Berlin (DE); Till Achinger, Berlin (DE); Gregor Fabritius, Berlin (DE)

(21) Appl. No.: 14/914,375

(22) PCT Filed: Aug. 29, 2013
(86) PCT No.: PCT/EP2013/067873

§ 371 Date: Feb. 25, 2016

(51) Int. Cl. H04N 5/272; H04N 1/60; H04N 5/222; G06T 5/50; H04N 1/00; H04N 5/225; H04N 9/07

(52) U.S. Cl. CPC H04N 5/272; H04N 5/2256; H04N 1/60; H04N 9/07; G06T 5/50; H04N 1/00209; H04N 5/2224; H04N 2201/0008; G06T 2207/20224; G06T 2207/10016; G06T 2207/10024

(57) ABSTRACT

The invention relates to a method and apparatus for obtaining an image file including an alpha channel using a photographic camera. The method comprises the steps of placing an object on a platform, illuminating a background of an object placed on the platform in a first color, taking a first image of an object, illuminating a background of an object placed on the platform in a second color, taking a second image of an object, creating transparency values between a first transparency value for a transparent pixel and a second transparency value for a non-transparent pixel from the first and second images, and taking a separate image with the photographic camera of an object placed on the platform different from the first and the second image. The image file includes an alpha channel based on the separate image and the transparency values obtained from the first and second images.

### CROSS-REFERENCE TO FOREIGN PRIORITY APPLICATION

The present application claims the benefit under 35 U.S.C. §119(b) of PCT/EP2013/067873, filed Aug. 29, 2013, entitled “A Method and an Apparatus for Obtaining an Image File Including an Alpha Channel With a Photographic Camera.”

### FIELD OF THE INVENTION

The invention relates to a method and an apparatus for obtaining an image file including an alpha channel using a photographic camera.

The invention further relates to a holding device for a photographic camera that can be used in a method and/or an apparatus for obtaining an image file including an alpha channel.

### BACKGROUND OF THE INVENTION

Methods and apparatuses for obtaining image files including an alpha channel are used, in particular, in commercial photography, and specifically in advertising photography of products, for example to be displayed on a website of an online store.

Different techniques have been developed to differentiate between foreground and background in an image, i.e., to identify the part of an image relating to an object or product on the one hand and the background against which the image of the object or product was photographed on the other hand. Preferably, the background of the image is eliminated or rendered transparent such that the object or product can be placed in front of an arbitrary or desired background. This process of combining an image of an object with a background can be referred to as alpha compositing, in which an alpha channel stores transparency information for each pixel in an image.

Examples of existing techniques include chroma keying methods as described in DE 10 2010 014 733 A1 or “color invariant chroma keying and colors spill neutralization for dynamic scenes and cameras” by Anselm Grundhofer, Daniel Kurz, Sebastian Thiele, Oliver Bimber in VIS COMPUT (2010) 26: 1167-1176; and further techniques as described in US 2011/0242334 A1; US 2003/0085907 A1; U.S. Pat. No. 6,301,382 B1; U.S. Pat. No. 6,490,006 B1; “image-based 3D photography using opacity hulls” by Matusik et al. in Proceedings of SIGGRAPH 2002, US 2003/0035061 A1; US 2011/0096183 A1; GB 2321814 A; the free mask solution of Schoepe in Schellerten, Germany, WO 2012/149983; U.S. Pat. No. 6,490,006 B1; U.S. Pat. No. 6,377,269 B1; US 2006/0008171 A1; U.S. Pat. No. 7,931,380 B2; GB 2464742 A; CA 2,280,481 A1; JP 2000/69498 A; and U.S. Pat. No. 7,071,953 B2. However, continuous improvements are sought to improve the results and to reduce the time and effort necessary.

It is therefore an object of the present invention to provide for an improved method and apparatus for obtaining an image file including an alpha channel using a photographic camera. It is further an object of the present invention to provide for a method and an apparatus for obtaining an image file including an alpha channel using a photographic camera, which are suitable to produce improved results and to reduce the time and effort necessary to produce those results. Further, it is an object of the present invention to provide for an improved holding device for a photographic camera which can be used, in particular, with the method and apparatus for obtaining an image file including an alpha channel using a photographic camera described herein.

### SUMMARY OF THE INVENTION

According to a first aspect of the invention, a method for obtaining an image file including an alpha channel is provided, the method comprising the steps of placing an object on a surface of a platform; illuminating a background of an object placed on the platform in a first color; taking a first image of an object placed on the platform with a photographic camera; illuminating a background of an object placed on the platform in a second color that is different from the first color; taking a second image of an object placed on the platform with the photographic camera; creating transparency values between a first transparency value for a transparent pixel and a second transparency value for a non-transparent pixel from said first and second images; wherein a pixel has the first transparency value, when a difference between an RGB value of a pixel in said first image and an RGB value of a corresponding pixel in said second image matches a maximum difference between RGB values of the pixels in said first image and the corresponding pixels in said second image; wherein a pixel has the second transparency value, when a difference between an RGB value of a pixel in said first image and an RGB value of a corresponding pixel in said second image is smaller than a maximum difference between the pixels in said first image of the plurality of images and the corresponding pixels in said second image of the plurality of images; characterized by the steps of taking a separate image with the photographic camera of an object placed on the platform different from said first and the second image; and creating an image file including an alpha channel based on said separate image and the transparency values obtained from said first and second images.

The inventive method in a first stage creates information that is stored in an alpha channel related to the transparency of an object, i.e., in particular, the information as to whether a pixel in an image relates to an object/foreground or to the background. The first transparency value means 100% transparency, i.e., a pixel with the first transparency value belongs to the background. The second transparency value or transparency values between the first and second transparency value indicate that a pixel is partly or not transparent. In particular, the second transparency value indicates a non-transparent pixel, i.e., a pixel belonging to a non-transparent foreground or object. Transparency values between the first and second transparency value indicate that the object is partly transparent in the region of the respective pixel. For example, if the object is a glass, a bottle, or another object through which the background can be seen at least partly, transparency values between the first and second transparency value will be created. The closer the transparency value is to the second transparency value, the less transparent is the respective part of the object and vice versa.

For example, the transparency values can be chosen between 0 and 1, with first and second transparency values being at the ends of the range. In particular, the first transparency value can be 0 and the second transparency value can be 1. However, if the method further comprises the inversion of transparency values, it can be preferred that the first transparency value is 1 and the second transparency value is 0. Values of 0 and 1 and in the range in between are preferably used represent the differences between the first and second images. However, other values and ranges can be used for the same purpose.

The transparency values are created by obtaining two different images of an object with the photographic camera, wherein the two images differ in the illumination of the background against which the object is photographed. The background is illuminated in a first color when the first image is taken and illuminated in a second color when the second image is taken. Preferably, the first and second colors have a high difference between their respective RGB values. It is particularly preferred to use complementary colors as first and second colors. However, black and white could also be used as first and second colors.

After the two images with the two different background colors are taken with the photographic camera, the RGB values of the pixels in the first image are compared to the RGB values of the respective pixels in the second image. A maximum difference is preferably determined by the difference between the first and second color in RGB values and/or can be a predetermined value, which is preferably adaptable by user input.

By matching a maximum difference, in particular, the following is meant: if the difference of the RGB values of the two images for a certain pixel equals the maximum difference or deviates from this maximum difference only by a certain, preferably predefined, amount, this pixel is considered to belong to the background since its color changed with the color change of the background illumination.

If the difference in RGB values for the two images of a certain pixel differs from the maximum or predetermined difference in RGB values determined by the difference between the first and second color, or deviates more by than the certain amount, this pixel does not belong to the background but rather belongs to the foreground. If there is no difference in RGB values between the two images for a certain pixel or if the difference is in a certain, predefined range, this pixel is considered to belong to the object or foreground and is not transparent since its RGB value is independent from the background illumination. Pixels with a difference in RGB values in the two images that do not fulfill the requirements of being classified as transparent or non-transparent, are considered to belong to a part of the object that is partly transparent. In this way, for each of the pixels a transparency value is created.

According to the inventive method, besides the two images taken with differently illuminated background for creating the transparency information for the alpha channel, in a second stage a further, separate image of the object placed on the platform is taken with the photographic camera. This separate image is different from the first and the second images and, in particular, is not used to create the transparency values, i.e., is not used to create the alpha channel information. Therefore, for taking the separate image no restrictions regarding illumination and lighting of the object and/or the background apply to this separate image, which are relevant for taking images that are used for creating alpha channel information. In particular, the separate image can be taken without a colored background illumination, and the lighting of the object can be optimized for obtaining a realistic and/or advantageous image of the object.

According to the invention, an image file is then created based on said separate image and including the alpha channel information with the transparency values that have been created using the first two images. In other words, different images are used for creating the alpha channel information and for actually representing the object together with the alpha channel information. In this way, the first two images used for creating the alpha channel information can be optimized regarding background lighting to obtain optimized alpha channel information. At the same time, the separate image can be optimized regarding representation of the object. By applying the alpha channel information created from the first two images to the separate image, the image file contains an optimized representation of the object together with the optimized transparency values contained in the alpha channel.

The sequence in which the first and second and separate images are taken can be varied: For example, the separate image can be taken after the first and second images are taken or before the first and second images are taken, or the separate image can be taken in between the first and second images. In particular, more than the two first and second images can be taken and used to obtain transparency values for the alpha channel. In particular, three, four, or more of those images with different background illumination can be used to create the alpha channel information. Further, also more than one separate image can be taken and combined with the alpha channel information created from the first and second or more images with different background illumination. The separate images can be used to create an optimized separate image and obtain an image file with this optimized separate image together with the alpha channel information. Also, each of several separate images can be combined with the alpha channel information to form a respective number of several image files, each containing one of the separate images together with the alpha channel information. In this way, for example, different lighting situations (e.g., relating to different moods or settings) can be used for taking the separate images, and each of those separate images then are combined with the alpha channel information into a respective image file such that differently lighted representations of the object are obtained.

Preferably, the background is illuminated by a display, which preferably contains a plurality of LEDs. The display is arranged preferably beneath and behind the platform, in particular, in a substantially horizontal plane below the platform and in an essentially vertical plane behind the platform. It is particularly preferred that the substantially horizontal display and the substantially vertical display are connected by an angled or curved display. In this way, a continuous background illumination can be achieved. In particular, it is preferred that light intensity and/or brightness of the illumination of the background is identical or at least very similar for the two colors used as background illumination for the two images.

The platform preferably is a transparent platform and can be made, for example, of acrylic glass. Further, it is preferred that the platform is matted to reduce reflections. In particular, it is preferred that the platform has a round, oval, elliptic, or otherwise curved cross section. Further, it is preferred that an edge of the platform facing the display for background illumination has a chamfer or bevel to reduce reflections.

The photographic camera focusing an object placed on the platform is preferably accommodated on a frame, which further preferably also accommodates the platform and the display for background illumination. Further, it is preferred that the photographic camera is held by a holding device described below.

The steps for creating the transparency values and alpha channel information and/or the image file are preferably performed by a processing unit connected to the photographic camera. Preferably, a control unit connected to the photographic camera and to the display is used to synchronize the illumination of the background with the taking of the images such that the first and second images are taken with the correct background illumination and the separate image is taken with a correct, preferably optimized, lighting.

According to a further aspect of the present invention, a method for obtaining an image file including an alpha channel is provided, the method comprising the steps of placing an object on a surface of a platform; illuminating a background of an object placed on the platform in a first color; taking a first image of an object placed on the platform with a photographic camera; illuminating a background of an object placed on the platform in a second color that is different from the first color; taking a second image of an object placed on the platform with the photographic camera; creating transparency values between a first transparency value for a transparent pixel and a second transparency value for a non-transparent pixel from said first and second images; wherein a pixel has the first transparency value, when a difference between an RGB value of a pixel in said first image and an RGB value of a corresponding pixel in said second image matches a maximum difference between RGB values of the pixels in said first image and the corresponding pixels in said second image; wherein a pixel has the second transparency value, when a difference between an RGB value of a pixel in said first image and an RGB value of a corresponding pixel in said second image is smaller than a maximum difference between the pixels in said first image of the plurality of images and the corresponding pixels in said second image of the plurality of images; preferably comprising the steps taking a separate image with the photographic camera of an object placed on the platform different from said first and the second image, and creating an image file including an alpha channel based on said separate image and the transparency values obtained from said first and second images; and further comprising the steps of rotating one or both of the photographic camera and the platform relative to the other about a rotation axis between sets of images taken by the photographic camera; a set of images comprising said first and second image and, preferably, said separate image file including an alpha channel.

According to this further aspect of the invention, more than one image file is created by repeating the process of taking first and second images and creating transparency values from those first and second images at least once after rotating the photographic camera relative to the platform, the platform relative to the photographic camera, or both. In this way, the object or product will be represented from different angles. For creating an image file, a set of images is used. As a minimum, such a set of images contains the first and second image with the different background colors from which the alpha channel information is obtained. If no separate image is taken in the set of images, the image file is created using the first or the second or a combination of the first and second image together with the alpha channel information. If, as described with reference to the first aspect of the invention, a separate image is taken and is part of the set of images, the image file is created by combining the separate image with the alpha channel information created using the first two images. An image file is created for each such set of images.

It is preferred that the platform is rotatable by a rotating mechanism relative to the camera. Preferably, the rotation axis for rotating the platform is arranged vertically. The relative rotation between the photographic camera and the platform between two sets of images is preferably predetermined; in particular, it is preferred that the platform is rotated by a predetermined amount about the vertical rotation axis relative to the photographic camera.

It is particularly preferred that the method comprises the steps of rotating the platform relative to the photographic camera and to a display about a vertical rotation axis by 10 degrees between each of a plurality of sets, in particular, a total of thirty-six sets, of images taken by the photographic camera; a set of images comprising a first and a second image and a separate image; wherein for each of the plurality of sets of images an image file including an alpha channel is created based on said separate image and the transparency values obtained from said first and second images of the respective set of images. Such a plurality of sets of images is particularly preferred to obtain a 360° representation of an object, for example, for product presentation on web pages by creating an image file for every 10°.

Further, it is particularly preferred that the method comprises the step of illuminating an object placed on the platform by a lighting device, preferably including a flash-unit, while the separate image of an object placed on the platform is taken with the photographic camera.

To optimize the representation of the object in the separate image, a lighting device is used to light the object. Preferably, a flash unit can be used to create an optimized lighting of the object. It is further preferred that the display is deactivated or illuminated in a neutral color when the separate image is taken.

It is further preferred to move the photographic camera relative to the platform between sets of images taken by the photographic camera; a set of images comprising said first and second image and, preferably, said separate image. The movement of the photographic camera can be a movement along a straight line or a curve. For example, the camera can be moved closer to the object or further away from the object. Another example is to move the camera into a position vertically above the object to take images from above the object. Further, the camera is preferably brought into different positions relative to the object to take images of the object from different angles.

In a further preferred embodiment the method comprises the step of rotating the photographic camera relative to the platform about a rotation axis, preferably about a horizontal rotation axis, between sets of images taken by the photographic camera; a set of images comprising said first and second image and, preferably, said separate image.

In addition or as an alternative to rotating the platform about a vertical rotation axis, it is preferred to rotate the photographic camera relative to the platform in order to create images of an object from different angles. Preferably, the photographic camera can be rotated about a horizontal rotation axis, which preferably intersects the centre of the platform or the centre of the object.

It is particularly preferred that the photographic camera can be moved in a plurality of directions and along a plurality of (straight or curved) lines in a guided, predetermined, and/or controlled way to increase the options for representing the object by images taken from different angles.

Regarding the creation of the alpha channel information, it is particularly preferred that the method comprises the step of inverting the transparency values by subtracting the transparency value from 1, such that an inverted value of 1 defines a foreground, preferably an object, and an inverted value of 0 defines a background. It is further preferred that the method comprises the step of exponentiating the transparency values or the inverted transparency values by a positive integer larger than 1, preferably by 2. A further preferred embodiment comprises the step of normalizing the exponentiated transparency values or the exponentiated inverted transparency onto a scale between 0 and 1. The previous embodiments regarding normalization, exponentiation, and inversion are particularly preferred with first and second transparency values between 0 and 1. However, normalization and inversion can also be applied for different representations of transparency with different value ranges.

Further, in a preferred embodiment the method comprises the steps of changing all (preferably inverted and/or normalized) transparency values below a lower threshold value to the first transparency value and/or changing all (preferably inverted and/or normalized) transparency values above an upper threshold value to the second transparency value.

The application of those threshold values has the advantage to allow for small deviations on one or both of the two ends of the transparency spectrum and to still clearly identify a pixel as belonging to the background or the foreground, respectively. In particular, it is preferred that a user can determine the threshold value or that predetermined threshold values are stored, in particular relating to different basic conditions. Such predetermined threshold values preferably are adaptable by user input.

In a further preferred embodiment, the method comprises the steps of identifying a reference pixel in said first and/or second image belonging to the background; identifying all pixels in said first and/or second image as background pixels, which have a difference in RGB value deviating in a predefined range from the difference in RGB value between the reference pixel and a corresponding pixel in the other one of said first and/or second image, and which are adjacent to the reference pixel and/or adjacent to another pixel with a difference in RGB value deviating in a predefined range from the difference in RGB value between the reference pixel and a corresponding pixel in the other one of said first and/or second image.

In this embodiment, starting from a reference pixel, adjacent pixels to this reference pixel are identified that are all belonging to a background. This embodiment is particularly preferred for highly transparent objects or objects with highly transparent parts. In those highly transparent parts, the difference in RGB values can be as high as the difference in RGB values that relates to the background. However, those pixels still belong to the object, albeit a transparent part of the object. Therefore, by identifying a reference pixel belonging to the background and only identifying additional pixels as belonging to the background that are adjacent to the reference pixel or one or more further pixels adjacent to the reference pixel that have a very similar difference in RGB values (within the predefined range) creates a definition of the background that contains pixels surrounding the object, only. The predefined range can be 0, i.e., only identifying background pixels with the same difference, or the predefined range can be +/−10%, +/−7.5%, +/−5%, +/−2.5%, +/−2%, +/−1.5%, +/−1%, or +/−0.5% of the difference value of the reference pixel.

This method is particularly preferred for objects having clear edges or borders and highly transparent parts only in inner areas. For example, when an image is created of a bottle or a glass, the center of the bottle or glass can be highly transparent, whereas the rim can be clearly identified as belonging to the object. By identifying a reference pixel belonging to the background and further performing the above-mentioned step of identifying further background pixels, only pixels surrounding the glass or bottle are identified as background, whereas all pixels within the bottle or glass are identified as belonging to the foreground, albeit with a high transparency value.

According to a further aspect of the invention, an apparatus for obtaining an image file including an alpha channel is provided, comprising a platform providing a surface for an object; a photographic camera focusing an object placed on the platform; a display adapted to illuminate a background of an object placed on the platform in at least two different colors; a processing unit connected to the photographic camera; a control unit connected to the photographic camera and to the display; the control unit being adapted to synchronize taking images of an object placed on the platform with the photographic camera with the illumination of the background by the display such that a first image of an object placed on the platform is taken by the photographic camera with the background illuminated in the first of the at least two different colors and a second image is taken by the photographic camera with the background illuminated in the second of the at least two different colors; the processing unit being adapted to create transparency values between a first transparency value for a transparent pixel and a second transparency value for a non-transparent pixel from said first and second images; wherein a pixel has the first transparency value, when a difference between an RGB value of a pixel in said first image and an RGB value of a corresponding pixel in said second image matches a maximum difference between RGB values of the pixels in said first image and the corresponding pixels in said second image; wherein a pixel has the second transparency value, when a difference between an RGB value of a pixel in said first image and an RGB value of a corresponding pixel in said second image is smaller than a maximum difference between the pixels in said first image of the plurality of images and the corresponding pixels in said second image of the plurality of images; characterized in that the control unit being adapted to initiate taking a separate image with the photographic camera of an object placed on the platform different from said first and the second image; and the processing unit being adapted to create an image file including an alpha channel based on said separate image and the transparency values obtained from said first and second images.

According to another aspect of the invention, an apparatus for obtaining an image file including an alpha channel is provided, comprising a platform providing a surface for an object; a photographic camera focusing an object placed on the platform; a display adapted to illuminate a background of an object placed on the platform in at least two different colors; a processing unit connected to the photographic camera; a control unit connected to the photographic camera and to the display; the control unit being adapted to synchronize taking images of an object placed on the platform with the photographic camera with the illumination of the background by the display such that a first image of an object placed on the platform is taken by the photographic camera with the background illuminated in the first of the at least two different colors and a second image is taken by the photographic camera with the background illuminated in the second of the at least two different colors; the processing unit being adapted to create transparency values between a first transparency value for a transparent pixel and a second transparency value for a non-transparent pixel from said first and second images; wherein a pixel has the first transparency value, when a difference between an RGB value of a pixel in said first image and an RGB value of a corresponding pixel in said second image matches a maximum difference between RGB values of the pixels in said first image and the corresponding pixels in said second image; wherein a pixel has the second transparency value, when a difference between an RGB value of a pixel in said first image and an RGB value of a corresponding pixel in said second image is smaller than a maximum difference between the pixels in said first image of the plurality of images and the corresponding pixels in said second image of the plurality of images; wherein preferably the control unit is adapted to initiate taking a separate image with the photographic camera of an object placed on the platform different from said first and the second image; and the processing unit preferably is adapted to create an image file including an alpha channel based on said separate image and the transparency values obtained from said first and second images; and wherein one or both of the photographic camera and the platform being rotatable relative to the other by a rotating mechanism about a rotation axis; and wherein the rotating mechanism is connected to the control unit and the control unit is adapted to initiate a relative rotation between the photographic camera and the platform between sets of images taken by the photographic camera; a set of images comprising said first and second image and, preferably, said separate image file including an alpha channel.

The apparatus according to the previous aspects can be further improved by a lighting device, preferably including a flash-unit, to illuminate an object placed on the platform, the lighting device being connected to the control unit; and wherein the control unit is adapted to synchronize taking the separate image of an object placed on the platform with the photographic camera with an illumination by the lighting device.

Further, the apparatus can be improved by a holding device for the photographic camera comprising a rotating frame being mounted on a support rotatable about a frame rotation axis, wherein the support is mounted on a base element rotatable about a support rotation axis which is orthogonal to the frame rotation axis; and wherein a fixture of the rotating frame is adapted to accommodate a photographic camera with an optical axis of a lens of the photographic camera being identical to the frame rotation axis.

As to the advantages, preferred embodiments and details of the apparatuses and preferred embodiments, reference is made to the corresponding aspects and embodiments described regarding the methods above and regarding the holding device in the following.

According to a further aspect of the invention, a holding device for a photographic camera is provided comprising a rotating frame being mounted on a support rotatable about a frame rotation axis, wherein the support is mounted on a base element rotatable about a support rotation axis which is orthogonal to the frame rotation axis; and wherein a fixture of the rotating frame is adapted to accommodate a photographic camera with an optical axis of a lens of the photographic camera being identical to the frame rotation axis.

Preferably, the holding device is particularly suitable to be used in an apparatus and in a method described above.

The holding device is adapted to accommodate the photographic camera such that a rotation of the rotating frame leads to a rotation of the photographic camera about its optical axis. This is particularly advantageous for changing the camera orientation between landscape and portrait format while focusing the same object. To achieve this, the frame rotation axis is identical with the optical axis of a lens of a photographic camera. Since photographic cameras can vary in their dimensions, the rotating frame contains a fixture to accommodate the photographic camera.

Preferably, the fixture is adapted to accommodate the photographic camera in different positions along a first adjustment direction in a plane perpendicular to the frame rotation axis and/or along a second adjustment direction perpendicular to the first adjustment direction and in a plane perpendicular to the frame rotation axis. In this way, the photographic camera can be placed in a rotating frame according to its specific dimensions such that its optical axis is identical with the frame rotation axis.

It is particularly preferable that the rotating frame is a ring and the frame rotation axis intersects the centre of the ring. Further, it is preferred that an inner perimeter of the ring has a flattened section and the fixture is arranged on the flattened section. This embodiment of the rotating frame is particularly advantageous for an easy handling of the holding device and particularly an easy fastening and arranging of a photographic camera to the fixture and to adapt the position of the photographic camera such that its optical axis is identical to the frame rotation axis.

### BRIEF DESCRIPTION OF THE DRAWINGS

Preferred embodiments of the invention shall now be described with reference to the attached drawings, in which

FIG. 1 is a cross section of an example of a preferred embodiment of an apparatus according to the invention;

FIG. 2 is a top view of the apparatus according to FIG. 1;

FIG. 3 is a schematic view of different elements of the apparatus according to FIG. 1;

FIG. 4 is a schematic flow diagram of some steps of an example of an embodiment of the inventive method;

FIG. 5 is a schematic view of a first and second and a separate image for use in the method according to the invention;

FIG. 6 is an example of an embodiment of a holding device according to the invention; and

FIG. 7 is a detail of the holding device according to FIG. 6 with a photographic camera.

### DETAILED DESCRIPTION OF THE PREFERRED EMBODIMENTS

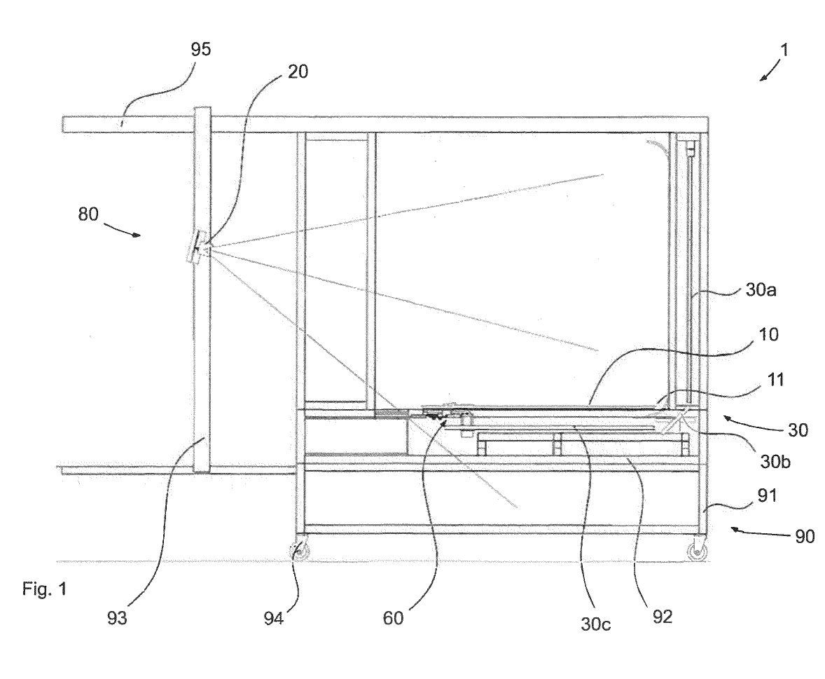

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

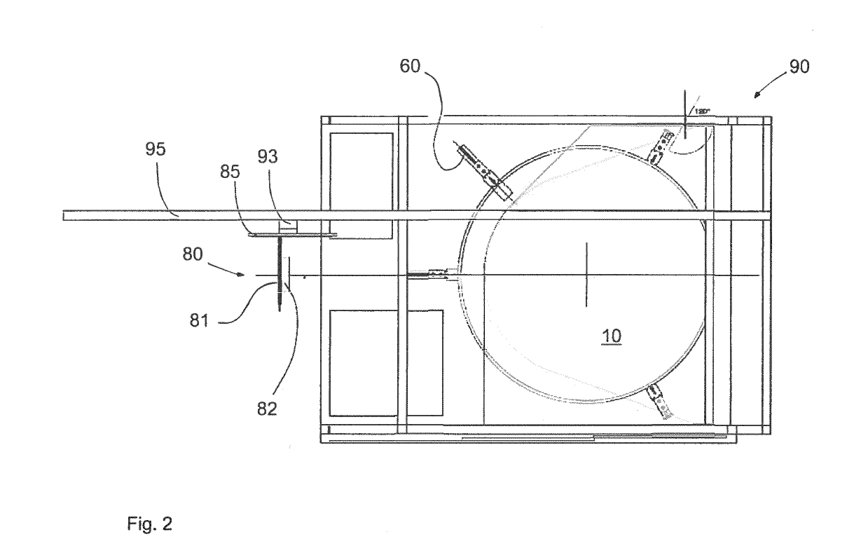

In FIGS. 1 and 2, an example of a preferred embodiment of an apparatus 1 for obtaining an image file including an alpha channel is depicted. The apparatus 1 comprises a platform 10 in the form of a circle and having a 45° bevel or chamfer 11. Platform 10 is preferably made of matted acrylic glass and is transparent. Platform 10 is mounted rotatable about a vertical rotation axis and can be rotated by a rotating mechanism 60. Platform 10 provides a surface for an object that is focused by a photographic camera 20.

Photographic camera 20 is mounted on a frame 90. In the embodiment depicted in FIGS. 1 and 2, frame 90 is placed on wheels 94 and thus renders the apparatus 1 mobile. Frame 90 comprises vertical elements 91, 93 and horizontal elements 92, 95. Photographic camera 20 is mounted on vertical element 93 via a holding device 80.

The apparatus 1 comprises a display 30 adapted to illuminate a background of an object placed on platform 10 in at least two different colors. In the embodiment of the apparatus 1 depicted in FIGS. 1 and 2, the display 30 comprises three parts: a horizontal part 30c arranged below platform 10, a vertical part 30a arranged behind platform 10, and an angled part 30b arranged between parts 30a, 30c. Preferably, all parts 30a, 30b, 30c of display 30 comprise a plurality of LEDs. Further, it is preferred that a part of frame 90, in particular, a horizontal element 92, accommodating the horizontal part 30c and/or angled part 30b is constructed as a sliding table or drawer to provide easy access to the display. In addition, it is preferred that the angled part 30b can be moved between an angled position to a horizontal position, wherein the horizontal position facilitates movement of the sliding table or drawer and the angled position improves background illumination.

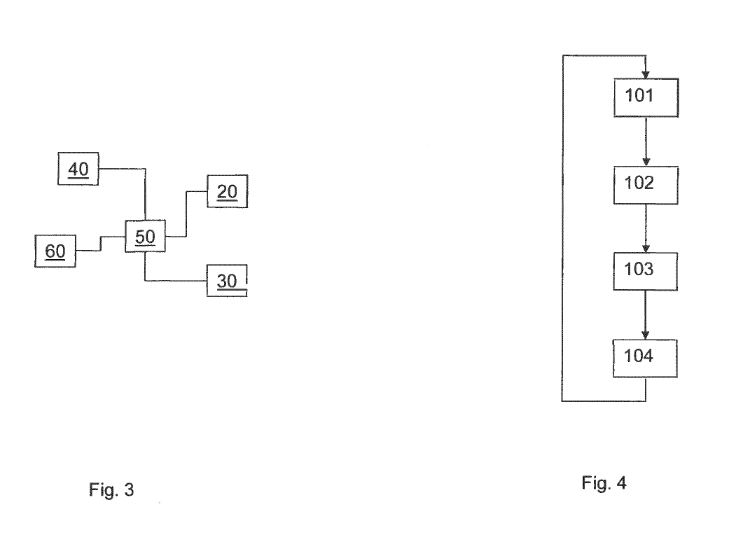

As depicted in FIG. 3, the photographic camera 20, the display 30, the rotating mechanism 60, and a processing unit 40 are all connected to a control unit 50. The processing unit 40 can additionally or alternatively be connected to the photographic camera 20. The control unit 50 is adapted to synchronize taking images of an object placed on the platform 10 with the photographic camera 20 with the illumination of the background by the display 30. The processing unit 40 is adapted to create the transparency values.

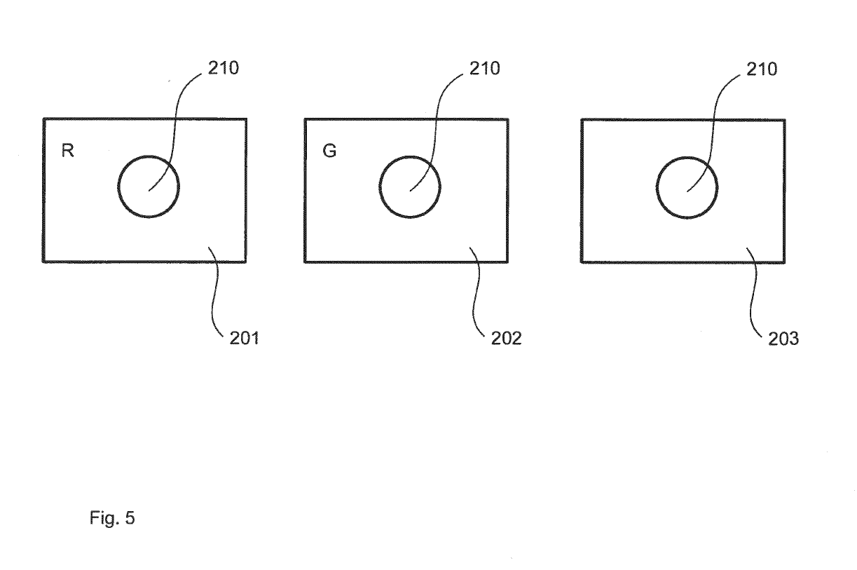

In FIGS. 4 and 5, the taking of a set of images is schematically depicted. FIG. 5 depicts a set of images 201, 202, 203. The first image 201 of an object 210 (in FIG. 5 depicted as a round circle) is taken with the photographic camera 20 while the display 30 illuminated the background of the object in red. The second image 202 of the object 210 is taken with the photographic camera 20 while the display 30 illuminated the background of the object in green. Further, a separate image 203 without a background illumination but with an optimized lighting of object 210 has been taken. This set of images 201, 202, 203 is then used to create the image file including an alpha channel.

As depicted in FIG. 4, in a first step 101 the first image 201 of the object 210 is taken with the background illuminated in red. In step 102 the second image 202 of the object 210 is taken with the background illuminated in green. In step 103 the separate image 203 of object 210 is taken without a background illumination but an optimized lighting of the object 210. After the taking of the set of images 201, 202, 203 in steps 101, 102, 103, rotating mechanism 60 is activated by control unit 50 and platform 10 is rotated in step 104 about a vertical rotation axis by 10°. After this rotation, the next set of images is taken by repeating steps 101, 102, 103. Subsequently, in a repetition of step 104, platform 10 is again rotated by rotating mechanism 60 by 10°. After thirty-six repetitions, control unit 50 ends the process of taking sets of pictures. In steps 101 and 102, control unit 50 synchronizes the display 30 and the photographic camera 20 such that the first image 201 of the object 210 is taken by the photographic camera 20 with the background illuminated in the first color, and the second image 202 is taken by the photographic camera 20 with the background illuminated in the second color.

After one or a plurality of sets of images 201, 202, 203 is taken, the information relating to those images is transferred to the processing unit 40 from the photographic camera and/or from control unit 50. Processing unit 40 then creates transparency values between the first transparency value for a transparent pixel and the second transparency value for a nontransparent pixel from said first and second images 201, 202, as described above. Further, processing unit 40 then creates an image file including alpha channel based on the separate image 203 and the transparency values obtained from first and second images 201 and 202.

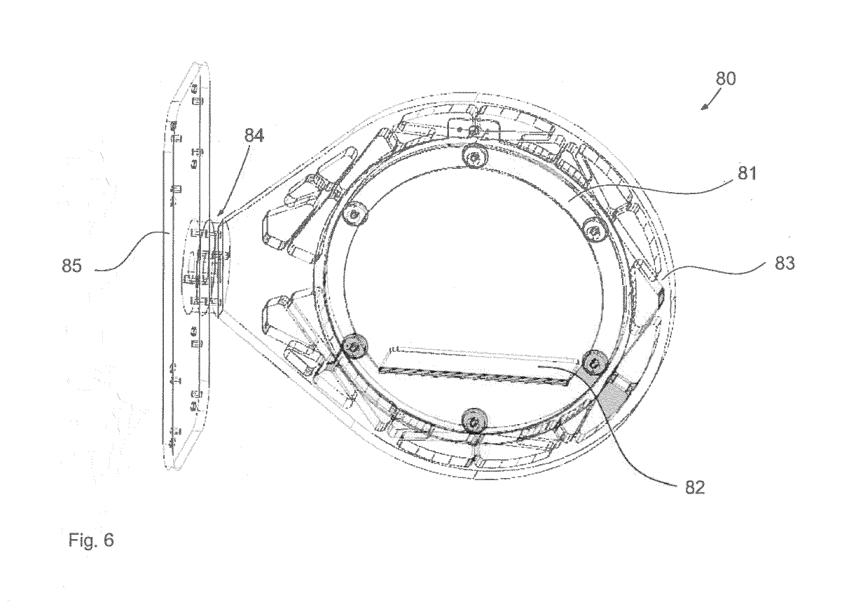

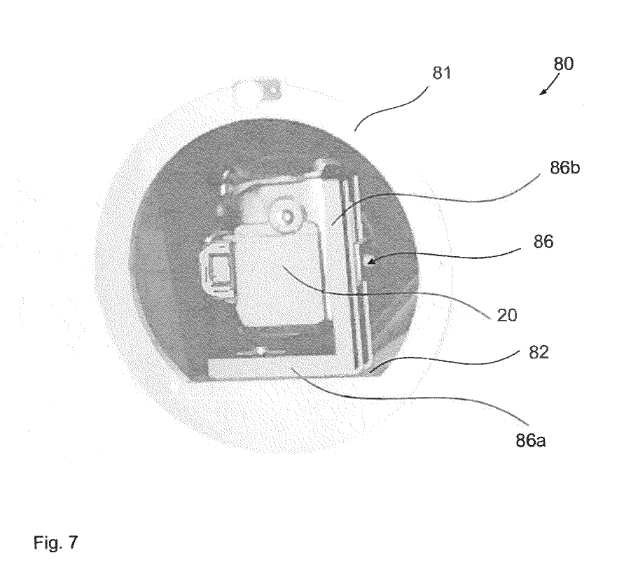

In FIGS. 6 and 7, an example of a preferred embodiment of a holding device 80 of a photographic camera 20 is depicted. Holding device 80 comprises a rotating frame 81 wherein the inner perimeter has a flattened section 82. In FIG. 7, a fixture 86 with two perpendicular legs 86a, 86b is arranged on a flattened section 82 of the rotating frame 81. Further, in FIG. 7 a photographic camera 20 is depicted, which is mounted on fixture 86. Fixture 86 is adapted to accommodate the photographic camera 20 in different positions along a first adjustment direction along leg 86a in a plane perpendicular to the frame rotation axis and along a second adjustment direction along leg 86b perpendicular to the first adjustment direction and in a plane perpendicular to the frame rotation axis.

As can be seen in FIGS. 6 and 7, the rotating frame 81 is a ring and the frame rotation axis intersects the centre of this ring. Further, rotating frame 80 is mounted on a support 83 and is rotatable about the frame rotation axis relative to the support 83. The support 83 is mounted on a base element 85 rotatable about a support rotation axis. In FIG. 7, the support rotation axis is horizontal and intersects pivot joint 84 in its center. Alternatively, the support rotation axis can also be horizontal, but located above the holding device 80 such that the support 83 can be pivoted along a segment of a circle. Further, the support can comprise two perpendicular support sections. The support can further comprise a handle to facilitate a pivoting or rotating movement of the support 83 relative to the base element 85. Support 83 can be fixed relative to base element 85 via fasteners.

In this way, the photographic camera 20 can be rotated about the optical axis of its lens by rotating the rotating frame about the frame rotation axis, which is identical with the optical axis. The rotation of the support about the support rotation axis further provides for an additional movement of the photographic camera to focus an object placed on a platform. In particular, the holding device 80 allows for an easy and reproducible change between landscape and portrait orientation of the photographic camera.

It is to be understood that variations and modifications can be made on the aforementioned structure and method without departing from the concepts of the present invention, and further it is to be understood that such concepts are intended to be covered by the following claims unless these claims by their language expressly state otherwise.

1.-15. (canceled)

16. A method for obtaining an image file including an alpha channel, the method comprising the steps of:
placing an object on a surface of a platform;
illuminating a background of an object placed on the platform in a first color;
taking a first image of an object placed on the platform with a photographic camera;
illuminating a background of an object placed on the platform in a second color that is different from the first color;
taking a second image of an object placed on the platform with the photographic camera;
creating transparency values between a first transparency value for a transparent pixel and a second transparency value for a non-transparent pixel from said first and second images, wherein a pixel has the first transparency value when a difference between an RGB value of a pixel in said first image and an RGB value of a corresponding pixel in said second image matches a maximum difference between RGB values of the pixels in said first image and the corresponding pixels in said second image, wherein a pixel has the second transparency value, when a difference between an RGB value of a pixel in said first image and an RGB value of a corresponding pixel in said second image is smaller than a maximum difference between the pixels in said first image of the plurality of images and the corresponding pixels in said second image of the plurality of images;
taking a separate image with the photographic camera of an object placed on the platform different from said first and the second image; and
creating an image file including an alpha channel based on said separate image and the transparency values obtained from said first and second images.

17. The method according to claim 16, further comprising the step of:
rotating one or both of the photographic camera and the platform relative to the other about a rotation axis between sets of images taken by the photographic camera, wherein a set of images comprises said first and second image.

18. The method according to claim 17, wherein the set of images further comprises said separate image.

19. The method according to claim 16, comprising the step of rotating the platform relative to the photographic camera to a display about a vertical rotation axis by 10 degrees between each of a plurality of sets of images taken by the photographic camera to create a set of images comprising a first and a second image and a separate image;
wherein, for each of the plurality of sets of images, an image file including an alpha channel is created based on said separate image and the transparency values obtained from said first and second images of the respective set of images.

20. The method according to claim 16, further comprising the step of illuminating an object placed on the platform by a lighting device, while the separate image of an object placed on the platform is taken with the photographic camera.

21. The method according to claim 16, further comprising the step of rotating the photographic camera relative to the platform about a rotation axis between sets of images taken by the photographic camera to create a set of images comprising said first and second image.

22. The method of claim 21, wherein the rotational axis is the horizontal axis and the set of images further comprises said separate image.

23. The method according to claim 16, comprising the step of inverting the transparency values by subtracting the transparency value from 1, such that an inverted value of 1 defines a foreground, such as an object, and an inverted value of 0 defines a background.

24. The method according to claim 16, comprising the step of exponentiating the transparency values or the inverted transparency values by a positive integer larger than 1.

25. The method according to claim 24, wherein the positive integer is at least 2.

26. The method according to claim 16, further comprising the step of normalizing the exponentiated transparency values or the exponentiated inverted transparency onto a scale of between 0 and 1.

27. The method according to claim 16, comprising the step of changing all transparency values below a lower threshold value to the first transparency value and changing all transparency values above an upper threshold value to the second transparency value.

28. The method according to claim 16, further comprising the step of changing all transparency values below a lower threshold value to the first transparency value or changing all transparency values above an upper threshold value to the second transparency value.

29. The method according to claim 16, further comprising the steps of:
identifying a reference pixel in said first and second image as belonging to the background; and
identifying all pixels in said first and second image as background pixels, which have a difference in RGB value deviating in a predefined range from the difference in RGB value between the reference pixel and a corresponding pixel in the other one of said first and second image, and which are adjacent to the reference pixel and adjacent to another pixel with a difference in RGB value deviating in a predefined range from the difference in RGB value between the reference pixel and a corresponding pixel in the other one of said first and second image.

30. An apparatus for obtaining an image file including an alpha channel comprising:
a platform providing a surface for an object;
a photographic camera focusing an object placed on the platform;
a display adapted to illuminate a background of an object placed on the platform in at least two different colors;
a processing unit connected to the photographic camera; and
a control unit connected to the photographic camera and to the display;
the control unit being adapted to synchronize taking images of an object placed on the platform with the photographic camera with the illumination of the background by the display such that a first image of an object placed on the platform is taken by the photographic camera with the background illuminated in the first of the at least two different colors and a second image is taken by the photographic camera with the background illuminated in the second of the at least two different colors;
wherein the processing unit is adapted to create transparency values between a first transparency value for a transparent pixel and a second transparency value for a nontransparent pixel from said first and second images, wherein a pixel has the first transparency value, when a difference between an RGB value of a pixel in said first image and an RGB value of a corresponding pixel in said second image matches a maximum difference between RGB values of the pixels in said first image and the corresponding pixels in said second image; and wherein a pixel has the second transparency value, when a difference between an RGB value of a pixel in said first image and an RGB value of a corresponding pixel in said second image is smaller than a maximum difference between the pixels in said first image of the plurality of images and the corresponding pixels in said second image of the plurality of images;
the control unit being adapted to initiate taking a separate image with the photographic camera of an object placed on the platform different from said first and the second image; and
the processing unit being adapted to create an image file including an alpha channel based on said separate image and the transparency values obtained from said first and second images.

31. The apparatus according to claim 30, wherein one or both of the photographic camera and the platform are rotatable relative to the other by a rotating mechanism about a rotation axis, the rotating mechanism is connected to the control unit and the control unit is adapted to initiate a relative rotation between the photographic camera and the platform between sets of images taken by the photographic camera, and a set of images comprises said first and second image.

32. The apparatus according to claim 31, wherein the set of images further comprises a separate image.

33. The apparatus according to claim 30, further comprising a lighting device to illuminate an object placed on the platform, the lighting device being connected to the control unit;
wherein the control unit is adapted to synchronize taking the separate image of an object placed on the platform with the photographic camera with an illumination by the lighting device.

34. The apparatus according to claim 30, further comprising a holding device for the photographic camera, the holding device comprising a rotating frame being mounted on a support rotatable about a frame rotation axis, wherein the support is mounted on a base element rotatable about a support rotation axis which is orthogonal to the frame rotation axis; and wherein a fixture of the rotating frame is adapted to accommodate a photographic camera with an optical axis of a lens of the photographic camera being identical to the frame rotation axis.

35. A holding device for a photographic camera comprising a rotating frame being mounted on a support rotatable about a frame rotation axis, wherein the support is mounted on a base element rotatable about a support rotation axis which is orthogonal to the frame rotation axis; and wherein a fixture of the rotating frame is adapted to accommodate a photographic camera with an optical axis of a lens of the photographic camera being identical to the frame rotation axis.
